(19) United States
(12) Patent Application Publication
(10) Pub. No.: US 2026/0034950 A1
(43) Pub. Date: Feb. 5, 2026

(54) MANAGEMENT DEVICE, MANAGEMENT METHOD, AND STORAGE MEDIUM

(71) Applicants: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); TOYOTA JIDOSHA KABUSHIKI KAISHA, Toyota-shi (JP)

(72) Inventors: Yuji TSUJI, Yokkaichi-shi (JP); Tomohiro OTSU, Yokkaichi-shi (JP); Kentaro ASHIBE, Yokkaichi-shi (JP); Ikuyoshi OTAKE, Toyota-shi (JP); Kanade KURIYAMA, Toyota-shi (JP)

(73) Assignees: AutoNetworks Technologies, Ltd., Yokkaichi-shi, Mie (JP); Sumitomo Wiring Systems, Ltd., Yokkaichi (JP); Sumitomo Electric Industries, Ltd., Osaka (JP); TOYOTA JIDOSHA KABUSHIKI KAISHA, Toyota-shi (JP)

(21) Appl. No.: 19/286,960

(22) Filed: Jul. 31, 2025

(30) Foreign Application Priority Data
Aug. 2, 2024 (JP) 2024-127700

(51) Int. Cl. B60R 16/023; B60R 16/03; H04L 67/12

(52) U.S. Cl. CPC B60R 16/0238; B60R 16/03; H04L 67/12

(57) ABSTRACT

A management device includes: one or more power supply control tables that are provided respectively for one or more devices connected to an in-vehicle network and that each define a relationship between first service identification information for identifying a service and a relay state for a power supply relay configured to switch power supply to the device on and off; an identification unit configured to identify second service identification information included in a message being transmitted in the in-vehicle network; and a control unit configured to control the power supply relay according to the power supply control table, if the second service identification information identified by the identification unit matches the first service identification information included in the power supply control table.

### CROSS-REFERENCE TO RELATED APPLICATIONS

This application claims priority to Japanese Patent Application No. 2024-127700 filed on Aug. 2, 2024, the entire content of which is incorporated herein by reference.

### TECHNICAL FIELD

The present disclosure relates to a management device, a management method, and a storage medium.

### BACKGROUND

Vehicles are equipped with various in-vehicle devices such as control-related ECUs (Electronic Control Units) for controlling an engine, a transmission, and the like, body-related ECUs for controlling a headlight, a power window, and the like, and information-related ECUs such as a navigation device and multimedia equipment. The in-vehicle devices are connected to an in-vehicle network and can be mutually communicated.

In association with enhancement of functionality of vehicles, each vehicle is equipped with a large number of ECUs. Thus, an energy saving feature that responds precisely to the condition of the vehicle is required.

Japanese Patent Publication No. 2015-081021 discloses a management device that identifies situations based on vehicle conditions, such as a situation where an occupant (or no occupant) is inside a vehicle, a situation where an occupant (or no occupant) is in a passenger seat, a situation where an occupant (or no occupant) is in a rear seat, a situation where the vehicle speed is equal to or more than a predetermined upper limit value, a situation where the shift position is not in Reverse, a situation where the shift position is in Park and the vehicle speed is zero, a situation where the shift position is in Drive, a situation where the shift position is in Drive and the vehicle speed is equal to or less than a predetermined lower limit value, a situation where an engine switch is on and low beam headlights are off, and a situation where an ambient temperature is equal to or higher than a predetermined lower limit value (or equal to or lower than a predetermined upper limit value), and that controls a power supply relay for switching the power supply to each ECU on and off according to the identified situation.

### SUMMARY

A management device according to an aspect of the present disclosure includes: one or more power supply control tables that are provided respectively for one or more devices connected to an in-vehicle network and that each define a relationship between first service identification information for identifying a service and a relay state for a power supply relay configured to switch power supply to the device on and off; an identification unit configured to identify second service identification information included in a message being transmitted in the in-vehicle network; and a control unit configured to control the power supply relay according to the power supply control table, if the second service identification information identified by the identification unit matches the first service identification information included in the power supply control table.

### BRIEF DESCRIPTION OF DRAWINGS

FIG. 1 shows an example of a configuration of an in-vehicle system according to an embodiment.

FIG. 2 is a block diagram showing an example of a hardware configuration of a control circuit in a management ECU according to the embodiment.

FIG. 3 is a functional block diagram showing examples of functions of the management

ECU according to the embodiment.

FIG. 4A shows a first example of a power supply control table.

FIG. 4B shows a second example of the power supply control table.

FIG. 5 shows a first example of a port table.

FIG. 6 shows a first example of a connection table.

FIG. 7 illustrates an example in which a new device is added in the in-vehicle system according to the embodiment.

FIG. 8 illustrates an example in which a power supply control table is added.

FIG. 9 shows a third example of the power supply control table.

FIG. 10 shows a second example of the port table.

FIG. 11 shows a second example of the connection table.

FIG. 12 is a flowchart showing an example of a power supply control process in the management ECU according to the embodiment.

FIG. 13 is a flowchart showing an example of a device addition process in the management ECU according to the embodiment.

### DETAILED DESCRIPTION OF PREFERRED EMBODIMENTS

The management device disclosed in Japanese Patent Publication No. 2015-081021 needs comprehensive determination using a plurality of pieces of information to identify situations. Thus, a process for identifying situations is complicated. In addition, only the situations that are clear to end users are assumed, so that it is difficult to precisely control power saving.

The present disclosure enables power saving to be precisely controlled without the need for a complicated process.

Hereinafter, the outline of an embodiment of the present disclosure will be listed and described.

In a first aspect, a management device according to the present embodiment includes: one or more power supply control tables that are provided respectively for one or more devices connected to an in-vehicle network and that each define a relationship between first service identification information for identifying a service and a relay state for a power supply relay configured to switch power supply to the device on and off; an identification unit configured to identify second service identification information included in a message being transmitted in the in-vehicle network; and a control unit configured to control the power supply relay according to the power supply control table, if the second service identification information identified by the identification unit matches the first service identification information included in the power supply control table. Thus, the on and off of the power supply to the corresponding device can be controlled, by identifying the service identification information included in the message being transmitted in the in-vehicle network. Therefore, it is possible to precisely control power saving without the need for a complicated process.

In a second according to the first aspect, the power supply control tables each further define a relationship between a first power source state which is a power source state specified and the relay state for the power supply relay, the management device further includes a detection unit configured to detect a power source state of a vehicle, and if a second power source state which is the power source state detected by the detection unit matches the first power source state included in the power supply control table, the control unit may control the power supply relay according to the power supply control table. Thus, the on and off of the power supply to the corresponding device can be controlled by using the power source state of the vehicle. Therefore, it is possible to more precisely control power saving without the need for a complicated process.

In a third aspect according to the first or the second aspect, the management device may further include an addition unit configured to, if a new device is added to the in-vehicle network, add a new power supply control table corresponding to the new device. Thus, the power supply to the new device added to the in-vehicle network can be controlled.

In a fourth aspect according to the third aspect, the power supply control table is associated with device identification information for identifying a device, the management device further comprises a reception unit configured to receive new device identification information for identifying the new device from the new device added to the in-vehicle network, and the addition unit may add the new power supply control table with which the new device identification information received by the reception unit is associated. Thus, the power supply control table for each device can be identified using the device identification information. Further, in a case where the new device is added to the in-vehicle network, the new power supply control table can be added in association with the new device identification information.

In a fifth aspect according to the fourth aspect, the management device further includes a storage unit configured to store therein a plurality of candidate tables which are candidates for device control tables, and the addition unit may select a candidate table associated with the new device identification information from the plurality of candidate tables stored in the storage unit, and may add the selected candidate table as a new device control table. Thus, if the new device is added to the in-vehicle network, the new device control table can be added easily.

In a sixth aspect according to any one of the first to the fifth aspects, the management device is a relay device configured to relay a message between a plurality of devices, and the identification unit may monitor a message being transmitted in the in-vehicle network, and may identify the second service identification information included in the message. Thus, the relay device connected to the in-vehicle network can perform the power supply control on the device connected to the in-vehicle network.

In a seventh aspect according to the sixth aspect, the management device further includes a port table that defines a correspondence relationship between a port connected to the device, and the power supply relay, and the control unit may identify the power supply relay corresponding to the port connected to the device from the port table, and may control the identified power supply relay according to the power supply control table. Thus, the power supply relay connected to the device can be identified, by using the port connected to the device, in the relay device.

In an eighth aspect according to the seventh aspect, the management device may further include a registration unit configured to, if a new device is added to the in-vehicle network, register a correspondence relationship between a port to which the new device is connected and a power supply relay connected to the new device, in the port table. Thus, if the new device is added to the in-vehicle network, the correspondence relationship between the port related to the new device and the power supply relay can be added to the port table.

In a ninth aspect, a management method according to the present embodiment includes: a step of identifying service identification information included in a message being transmitted in an in-vehicle network; and a step of, if first service identification information which is service identification information in one or more power supply control tables that are provided respectively for one or more devices connected to the in-vehicle network and that each define a relationship between service identification information for identifying a service and a relay state for a power supply relay configured to switch power supply to the device on and off matches second service identification information which is identified service identification information, controlling the power supply relay according to the power supply control table. Thus, the on and off of the power supply to the corresponding device can be controlled by identifying the service identification information included in the message being transmitted in the in-vehicle network. Therefore, it is possible to precisely control power saving without the need for a complicated process.

In a tenth aspect, a non-transitory computer-readable storage medium according to the present embodiment in which a management program is stored, the management program causing a computer to perform: a step of identifying service identification information included in a message being transmitted in an in-vehicle network; and a step of, if first service identification information which is service identification information in one or more power supply control tables that are provided respectively for one or more devices connected to the in-vehicle network and that each define a relationship between service identification information for identifying a service and a relay state for a power supply relay configured to switch power supply to the device on and off matches second service identification information which is identified service identification information, controlling the power supply relay according to the power supply control table. Thus, the on and off of the power supply of the corresponding device can be controlled by identifying the service identification information included in the message being transmitted in the in-vehicle network. Therefore, it is possible to precisely control power saving without the need for a complicated process.

The present disclosure can be realized not only as a management device including a characteristic configuration, a management method including characteristic steps, and a management program for causing the management device to perform a characteristic process, as described above, but also as a management system including the management device, or a part or the entirety of the management device can be realized as a semiconductor integrated circuit.

Hereinafter, an embodiment of the present disclosure will be described in detail with reference to the drawings. At least some parts of the embodiment described below may be combined together as desired.

### In-Vehicle System

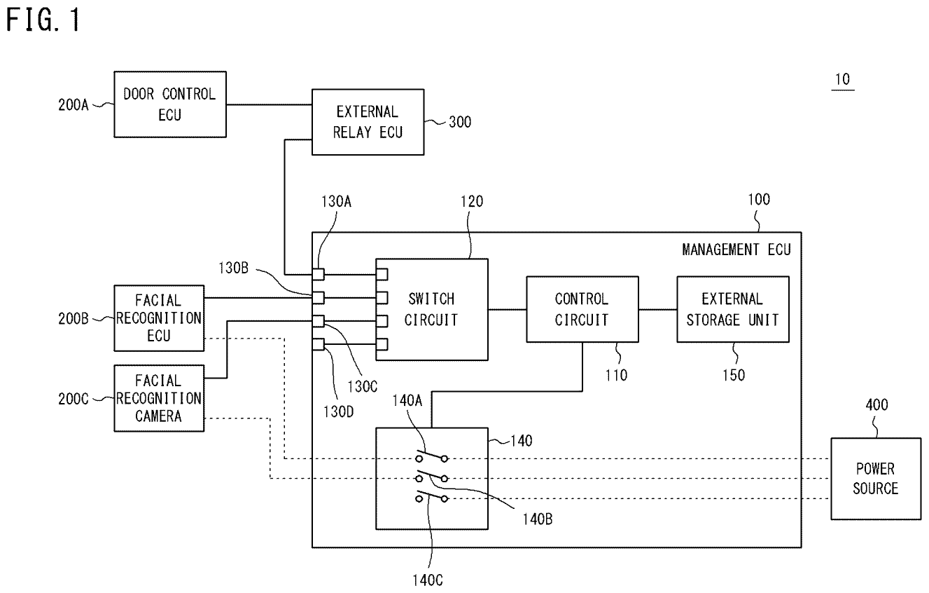

FIG. 1 shows an example of a configuration of an in-vehicle system according to the embodiment.

An in-vehicle system 10 includes a management ECU 100, a door control ECU 200A, a facial recognition ECU 200B, a facial recognition camera 200C, an external relay ECU 300, and a power source 400.

At least a part of an in-vehicle network is configured by the management ECU 100 and the external relay ECU 300. The management ECU 100 and the external relay ECU 300 are mutually connected via a signal line (network cable).

A plurality of devices can be connected to the external relay ECU 300, and the external relay ECU 300 relays communication between the plurality of connected devices. For example, the external relay ECU 300 is an Ethernet switch (“Ethernet” is a registered trademark).

For example, the management ECU 100 is a relay device. More specifically, the management ECU 100 is an Ethernet switch. In a specific example, the management ECU 100 has functions of a Layer 2 switch (L2 switch) and a Layer 3 switch (L3 switch).

The management ECU 100 includes a plurality of ports 130A, 130B, 130C, 130D. The external relay ECU 300 includes a plurality of ports (not shown). The first port of the external relay ECU 300 and the port 130A of the management ECU 100 are connected with each other via an Ethernet cable.

The door control ECU 200A is connected to the second port of the external relay ECU 300 via an Ethernet cable.

The door control ECU 200A is an ECU for controlling doors of a vehicle. For example, the door control ECU 200A can control the door lock of the vehicle.

The facial recognition ECU 200B is connected to the port 130B of the management ECU 100 via an Ethernet cable. The facial recognition camera 200C is connected to the port 130C of the management ECU 100 via an Ethernet cable.

The facial recognition camera 200C includes, for example, an imaging element such as a CCD (Charge Coupled Device) or a CMOS (Complementary Metal Oxide Semiconductor). The facial recognition camera 200C captures the face of a person (e.g., a driver) who has come close to the vehicle, and outputs the captured image.

The facial recognition ECU 200B processes the captured image outputted from the facial recognition camera 200C. The facial recognition ECU 200B recognizes the face of a subject through the image processing. In the facial recognition ECU 200B, data indicating facial features (e.g., the positions of the eyes, the nose, and the mouth) of a user (driver) of the vehicle is registered in advance. The facial recognition ECU 200B extracts the facial feature data of the subject from the image captured by the facial recognition camera 200C, and compares the extracted feature data with the registered data, thereby performing user authentication for the subject.

The in-vehicle system 10 is, for example, an IP (Internet Protocol) network. The door control ECU 200A, the facial recognition ECU 200B, and the facial recognition camera 200C are network nodes, and transmit and receive IP packets. An IP packet is an example of a “message”. As used herein, a “message” is a unit of data communication defined by communication protocol. For example, a packet is a “message” in TCP (Transmission Control Protocol) or UDP (User Datagram Protocol), and an Ethernet frame is a “message” in Ethernet. A CAN frame is a “message” in CAN (Control Area Network). That is, a “message” is a PDU (Protocol Data Unit). At least a part of the in-vehicle system 10 may be a CAN network.

For example, a service is provided by one or more ECUs. In a specific example, Smart Entry Service is provided by the door control ECU 200A, the facial recognition ECU 200B, and the facial recognition camera 200C in cooperation with each other. The Smart Entry Service is a service that locks and unlocks doors of the vehicle through facial recognition. The door control ECU 200A, the facial recognition ECU 200B, and the facial recognition camera 200C transmit and receive messages with each other for the Smart Entry Service.

### Configuration of Management ECU

Hereinafter, a configuration of the management ECU according to the embodiment will be described.

As described above, the management ECU 100 is a relay device, and has functions of the L2 switch and the L3 switch.

The management ECU 100 is also a power supply management device. The management ECU 100 manages the power supply to the subordinate ECUs. Specifically, the management ECU 100 individually manages the power supply to the facial recognition ECU 200B and the power supply to the facial recognition camera 200C. The management ECU 100 is an example of a “management device”.

The management ECU 100 is also an extension device that extends the functionality of the vehicle. The management ECU 100 allows devices to be connected to/disconnected from the ports 130A, 130B, 130C, 130D. That is, a new device can be connected to an available port 130D, for example. The new device connected to the management ECU 100 extends the functionality of the vehicle. For example, the facial recognition ECU 200B and the facial recognition camera 200C can be removed from the ports 130B, 130C, and other new devices can be connected to the ports 130B, 130C, respectively.

As shown in FIG. 1, the management ECU 100 includes a control circuit 110, a switch circuit 120, a relay unit 140, and an external storage unit 150.

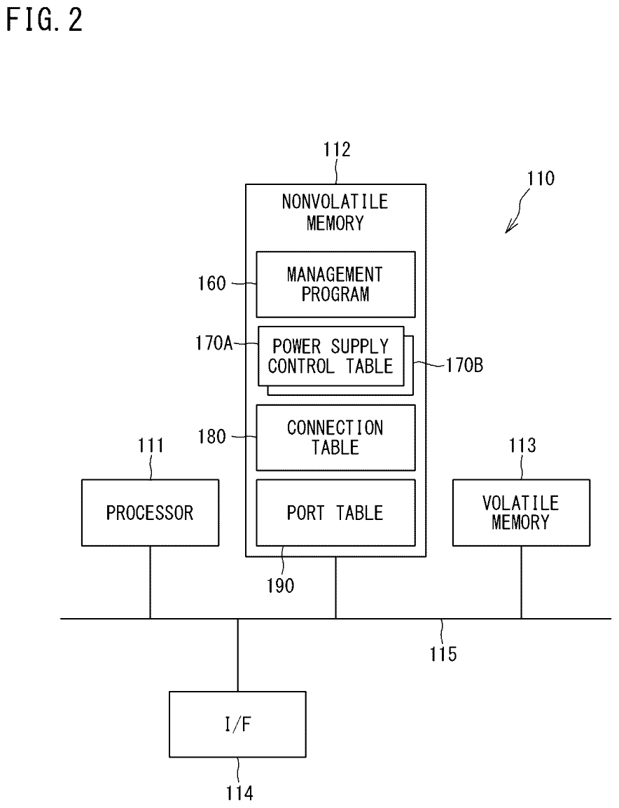

FIG. 2 is a block diagram showing an example of a hardware configuration of the control circuit in the management ECU according to the embodiment. The control circuit 110 includes a processor 111, a nonvolatile memory 112, a volatile memory 113, and an interface (hereinafter, also referred to as “I/F”) 114. The processor 111 is connected, via a bus 115, to the nonvolatile memory 112, the volatile memory 113, and the I/F 114.

The volatile memory 113 is, for example, a semiconductor memory such as an SRAM (Static Random Access Memory) or a DRAM (Dynamic Random Access Memory). The nonvolatile memory 112 is, for example, a flash memory, a hard disk, a ROM (Read Only Memory), or the like. A management program 160 which is a computer program, and data to be used in execution of the management program 160 are stored in the nonvolatile memory 112. Functions of the management ECU 100 described below are implemented by the management program 160 being executed by the processor 111.

The processor 111 is, for example, a CPU (Central Processing Unit). However, the processor 111 is not limited to a CPU. The processor 111 may be a GPU (Graphics Processing Unit). In a specific example, the processor 111 is a multicore processor. The processor 111 may be a single core processor. The processor 111 is configured to be able to execute a computer program. The processor 111 may be, for example, an ASIC (Application Specific Integrated Circuit), or may be a programmable logic device such as an FPGA (Field Programmable Gate Array). In this case, the ASIC or the programmable logic device is designed to be able to implement the same function as that implemented by the management program 160 being executed.

The I/F 114 includes an input/output interface. Specifically, the interface 114 of the control circuit 110 is connected to the switch circuit 120, the relay unit 140, and the external storage unit 150. The processor 111 can control the switch circuit 120, the relay unit 140, and the external storage unit 150 connected to the interface 114.

One or more power supply control tables 170A, 170B, a connection table 180, and a port table 190 are stored in the nonvolatile memory 112. The power supply control tables 170A, 170B, the connection table 180, and the port table 190 will be described below.

Referring back to FIG. 1, the switch circuit 120 is the L2 switch and the L3 switch. The switch circuit 120 includes a plurality of ports. The ports of the switch circuit 120 are connected to the ports 130A, 130B, 130C, 130D on a one-to-one basis via signal lines.

The relay unit 140 includes a plurality of relays 140A, 140B, 140C. The relays 140A, 140B, 140C are each an example of a “power supply relay”. The relay unit 140 is connected to the power source 400 outside the management ECU 100 via power lines. In FIG. 1, each connection between a plurality of elements via a signal line is indicated by a solid line, and each connection between a plurality of elements via a power line is indicated by a broken line.

The relay 140A is disposed between the facial recognition ECU 200B and the power source 400. The power source 400 includes, for example, an auxiliary battery. When the relay 140A is in the ON state, power is supplied from the power source 400 to the facial recognition ECU 200B, and the facial recognition ECU 200B can start up. When the relay 140A is in the OFF state, supply of power from the power source 400 to the facial recognition ECU 200B is stopped, and the facial recognition ECU 200B stops.

The relay 140B is disposed between the facial recognition camera 200C and the power source 400. When the relay 140B is in the ON state, power is supplied from the power source 400 to the facial recognition camera 200C, and the facial recognition camera 200C can start up. When the relay 140B is in the OFF state, supply of power from the power source 400 to the facial recognition camera 200C is stopped, and the facial recognition camera 200C stops.

The signal lines (Ethernet cables) extending from the ports 130B, 130C are paired one-to-one with the power lines extending from the relay unit 140, respectively. That is, the signal line and the power line connected to the facial recognition ECU 200B are paired, and the signal line and the power line connected to the facial recognition camera 200C are paired. For example, a connector is attached to the ends of the signal line and the power line paired such that a harness is formed. The harness is connected to a target extension device (facial recognition ECU 200B or facial recognition camera 200C).

For example, the external storage unit 150 is, for example, a nonvolatile memory such as a flash memory, a hard disk, or a ROM. For example, the external storage unit 150 has a larger storage capacity than the nonvolatile memory 112 of the control circuit 110.

### Functions of Management ECU

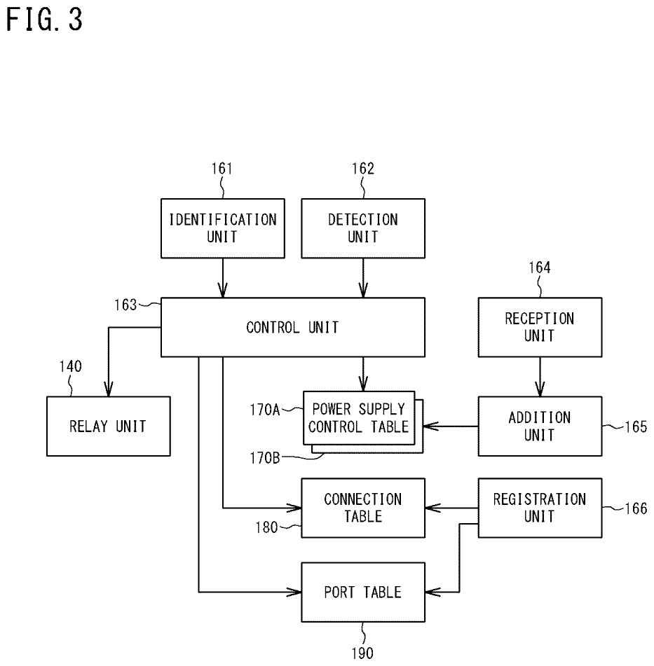

Hereinafter, the functions of the management ECU according to the embodiment will be described. FIG. 3 is a functional block diagram showing examples of the functions of the management ECU according to the embodiment.

Each function of an identification unit 161, a detection unit 162, a control unit 163, a reception unit 164, an addition unit 165, and a registration unit 166 is implemented by the management program 160 being executed by the processor 111 of the management ECU 100.

The identification unit 161 identifies service identification information (second service identification information) included in a message being transmitted in the in-vehicle network. For example, the service identification information is a port number. In a specific example, a message is a TCP or UDP packet, and service identification information is a port number in TCP or UDP. The port number is assigned to each service (application). In a specific example, the port number is a dynamic and private port number in a range from “49152” to “65535”. For example, port numbers “50200”, “50201”, and “50202” are assigned to “Smart Entry Service”. In another example, service identification information is a CAN ID in a CAN network. In still another example, service identification information may be service identification information (message ID in SOME/IP) in a service-oriented protocol such as SOME/IP. An NM (network management) function which causes an ECU to transition from a sleep state to an active state through reception of a message may be used. Specifically, the NM function is a function that divides the in-vehicle network into clusters each called PNC (Partial Network Cluster) for the respective services, that wakes up an ECU belonging to a PNC to be used in execution of a service, and that causes ECUs belonging to the other PNCs to sleep. Each message (NM message) which is used in the NM includes a specification of which PNC to wake up (start up). An ECU that has received the NM message wakes up if the specified PNC matches a PNC to which the ECU belongs, and maintains a sleep state if the specified PNC does not match the PNC to which the ECU belongs. In this case, the service identification information may be a PNC.

In a case where the port number (service identification information) identified by the identification unit 161 matches any of the port numbers (first service identification information) included in the power supply control tables 170A, 170B, the control unit 163 controls the relays 140A, 140B according to the power supply control tables 170A, 170B.

Here, the power supply control tables 170A, 170B will be described. The management ECU 100 stores therein the power supply control tables 170A, 170B for the respective subordinate devices (i.e., devices to be managed) within the management ECU 100. That is, the power supply control table 170A is a power supply control table for the facial recognition ECU 200B, and the power supply control table 170B is a power supply control table for the facial recognition camera 200C.

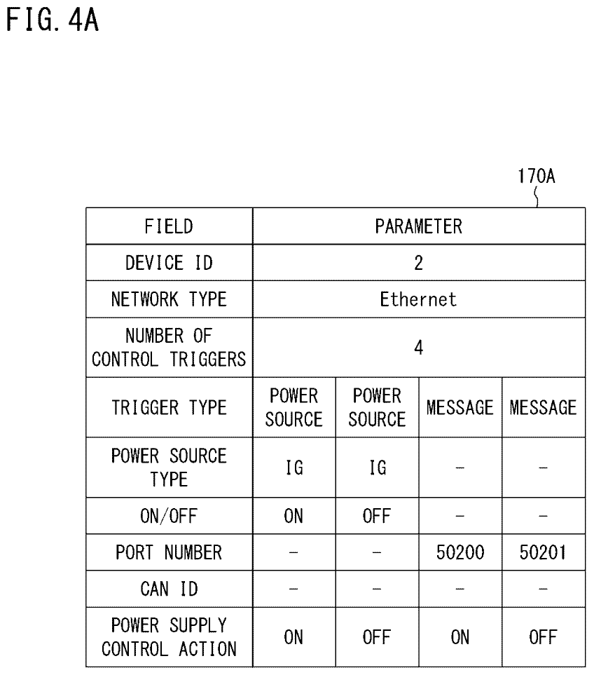

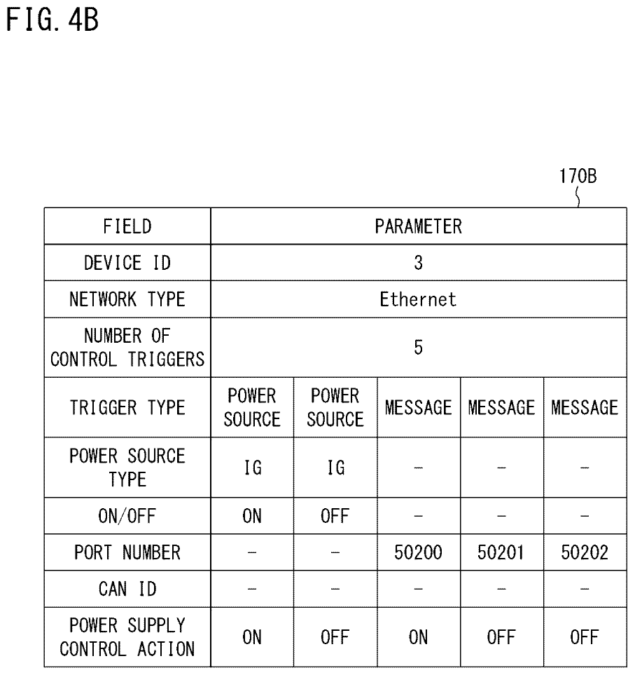

FIG. 4A shows a first example of the power supply control table. In FIG. 4A, the power supply control table 170A for the facial recognition ECU 200B is shown. The power supply control table includes parameters in the fields for a device ID, a network type, the number of control triggers, a trigger type, a power source type, ON/OFF, a port number, a CAN ID, and a power supply control action.

The device ID is identification information assigned to each subordinate device within the management ECU 100. A device ID of the facial recognition ECU 200B is “2”. The device ID is an example of device identification information.

The network type supported by the device is stored as a parameter in the “network type” field. Specifically, one of “Ethernet” and “CAN” is stored as a parameter corresponding to the “network type” field. The network type supported by the facial recognition ECU 200B is “Ethernet”.

The “number of control triggers” field indicates the number of triggers for power supply control, that is, the number of triggers for controlling a relay connected to the device (hereinafter, also referred to as “power supply control trigger”) such that the relay is turned on or off. The number of control triggers defined in the power supply control table 170A is the number of power supply control triggers for controlling the relay 140A connected to the facial recognition ECU 200B. In an example in FIG. 4A, a parameter in the “number of control triggers” field is “4”.

The “trigger type”, “power source type”, “ON/OFF”, “port number”, “CAN ID”, and “power supply control action” fields define the contents of each power supply control trigger. The power supply control trigger is composed of a combination of the conditions for controlling the power supply (relay) to the device, and a control content (power supply is turned on or off). That is, the “trigger type”, “power source type”, “ON/OFF”, “port number”, and “CAN ID” fields each define the condition for power supply control, and the “power supply control action” field defines the control content for power supply. That is, if the conditions defined in the “trigger type”, “power source type”, “ON/OFF”, “port number”, and “CAN ID” fields are satisfied, control is performed according to the content defined in the “power supply control action” field.

The “trigger type” field indicates the type of power supply control trigger. The power supply control triggers include a power supply control trigger to be caused by a power source state and a power supply control trigger to be caused by a message. Each subordinate device within the management ECU 100 may start up or stop, in a case where a specific power source state occurs. The power supply control trigger to be caused by a power source state defines power supply control to be performed in the case where the specific power source state occurs. Each subordinate device within the management ECU 100 may also start up or stop, in a case where a specific message is being transmitted in the in-vehicle network. The power supply control trigger to be caused by a message defines power supply control that is performed in the case where the specific message is being transmitted in the in-vehicle network. A parameter “power source” corresponding to the “trigger type” field indicates the power supply control trigger to be caused by a power source state, and a parameter “message” corresponding to the “trigger type” field indicates the power supply control trigger to be caused by a message.

The “power source type” and “ON/OFF” fields indicate the conditions for a power source state in a power supply control trigger to be caused by a power source state. As the power source type, for example, IG, ACC, and +B are included. That is, the power source 400 includes IG, ACC, and +B power sources. For example, IG refers to a power source that turns on in a state where the vehicle can travel and that turns off in a state where the vehicle cannot travel. For example, ACC refers to a power source that turns on in a state where a specific switch provided in the vehicle is in a pressed-down state and that turns off in a state where the above switch is not pressed. For example, +B refers to a constant power source, that is, a power source that is on irrespective of the state of the vehicle. The “ON/OFF” field indicates whether the power source specified in the “power source type” field is in the ON state or the OFF state.

The “port number” and “CAN ID” fields indicate the conditions for a message in a power supply control trigger to be caused by a message. In the “port number” field, in a case where the network type is “Ethernet”, a port number as service identification information is specified as a parameter. In the “CAN ID” field, in a case where the network type is “CAN”, a CAN ID as service identification information is specified as a parameter. In another example, a message ID in SOME/IP or a PNC in NM may be specified as service identification information in the power supply control table 170A.

In the “power supply control action” field, “ON” or “OFF” is specified as a parameter. A parameter “ON” for the “power supply control action” indicates control for turning a corresponding relay on, and a parameter “OFF” for the “power supply control action” indicates control for turning the corresponding relay off.

One or more power supply control triggers are defined for each device. Four power supply control triggers are provided for the facial recognition ECU 200B.

In a first power supply control trigger for the facial recognition ECU 200B, a parameter “power source” for the “trigger type” field, a parameter “IG” for the “power source type” field, a parameter “ON” for the “ON/OFF” field, and a parameter “ON” for the “power supply control action” field are specified. Since the first power supply control trigger for the facial recognition ECU 200B is a power supply control trigger to be caused by a power source state, no parameter is specified for the “port number” field or the “CAN ID” field. In a case where the power source state becomes IG ON, the relay 140A is turned on, due to the first power supply control trigger for the facial recognition ECU 200B.

In a second power supply control trigger for the facial recognition ECU 200B, a parameter “power source” for the “trigger type” field, a parameter “IG” for the “power source type” field, a parameter “OFF” for the “ON/OFF” field, and a parameter “OFF” for the “power supply control action” field are specified. Since the second power supply control trigger for the facial recognition ECU 200B is a power supply control trigger to be caused by a power source state, no parameter is specified for the “port number” field or the “CAN ID” field. In a case where the power source state becomes IG OFF, the relay 140A is turned off, due to the second power supply control trigger for the facial recognition ECU 200B.

In a third power supply control trigger for the facial recognition ECU 200B, a parameter “message” for the “trigger type” field, a parameter “50200” for the “port number” field, and a parameter “ON” for the “power supply control action” field are specified. Since the third power supply control trigger for the facial recognition ECU 200B is a power supply control trigger to be caused by a message, no parameter is specified for the “power source type” field or the “ON/OFF” field. Since the network type supported by the facial recognition ECU 200B is “Ethernet”, no parameter is specified for the “CAN ID” field. In a case where a message including a port number of “50200” is being transmitted in the in-vehicle network, the relay 140A is turned on, due to the third power supply control trigger for the facial recognition ECU 200B.

In a fourth power supply control trigger for the facial recognition ECU 200B, a parameter “message” for the “trigger type” field, a parameter “50201” for the “port number” field, and a parameter “OFF” for the “power supply control action” field are specified. Since the fourth power supply control trigger for the facial recognition ECU 200B is a power supply control trigger to be caused by a message, no parameter is specified for the “power source type” field or the “ON/OFF” field. Since the network type supported by the facial recognition ECU 200B is “Ethernet”, no parameter is specified for the “CAN ID” field. In a case where a message including a port number of “50201” is being transmitted in the in-vehicle network, the relay 140A is turned off, due to the fourth power supply control trigger for the facial recognition ECU 200B.

FIG. 4B shows a second example of the power supply control table. In FIG. 4B, the power supply control table 170B for the facial recognition camera 200C is shown.

A device ID of the facial recognition camera 200C is “3”.

The network type supported by the facial recognition camera 200C is “Ethernet”.

The number of control triggers defined in the power supply control table 170B is the number of power supply control triggers for controlling the relay 140B connected to the facial recognition camera 200C. In an example in FIG. 4B, a parameter in the “number of control triggers” field is “5”.

In a first power supply control trigger for the facial recognition camera 200C, a parameter “power source” for the “trigger type” field, a parameter “IG” for the “power source type” field, a parameter “ON” for the “ON/OFF” field, and a parameter “ON” for the “power supply control action” field are specified. Since the first power supply control trigger for the facial recognition camera 200C is a power supply control trigger to be caused by a power source state, no parameter is specified for the “port number” field or the “CAN ID” field. In a case where the power source state becomes IG ON, the relay 140B is turned on, due to the first power supply control trigger for the facial recognition camera 200C.

In a second power supply control trigger for the facial recognition camera 200C, a parameter “power source” for the “trigger type” field, a parameter “IG” for the “power source type” field, a parameter “OFF” for the “ON/OFF” field, and a parameter “OFF” for the “power supply control action” field are specified. Since the second power supply control trigger for the facial recognition camera 200C is a power supply control trigger to be caused by a power source state, no parameter is specified for the “port number” field or the “CAN ID” field. In a case where the power source state becomes IG OFF, the relay 140B is turned off, due to the second power supply control trigger for the facial recognition camera 200C.

In a third power supply control trigger for the facial recognition camera 200C, a parameter “message” for the “trigger type” field, a parameter “50200” for the “port number” field, and a parameter “ON” for the “power supply control action” field are specified. Since the third power supply control trigger for the facial recognition camera 200C is a power supply control trigger to be caused by a message, no parameter is specified for the “power source type” field or the “ON/OFF” field. Since the network type supported by the facial recognition camera 200C is “Ethernet”, no parameter is specified for the “CAN ID” field. In the case where a message including a port number of “50200” is being transmitted in the in-vehicle network, the relay 140B is turned on, due to the third power supply control trigger for the facial recognition camera 200C.

In a fourth power supply control trigger for the facial recognition camera 200C, a parameter “message” for the “trigger type” field, a parameter “50201” for the “port number” field, and a parameter “OFF” for the “power supply control action” field are specified. Since the fourth power supply control trigger for the facial recognition camera 200C is a power supply control trigger to be caused by a message, no parameter is specified for the “power source type” field or the “ON/OFF” field. Since the network type supported by the facial recognition camera 200C is “Ethernet”, no parameter is specified for the “CAN ID” field. In a case where a message including a port number of “50201” is being transmitted in the in-vehicle network, the relay 140B is turned off, due to the fourth power supply control trigger for the facial recognition camera 200C.

In a fifth power supply control trigger for the facial recognition camera 200C, a parameter “message” for the “trigger type” field, a parameter “50202” for the “port number” field, and a parameter “OFF” for the “power supply control action” field are specified. Since the fifth power supply control trigger for the facial recognition camera 200C is a power supply control trigger to be caused by a message, no parameter is specified for the “power source type” field or the “ON/OFF” field. Since the network type supported by the facial recognition camera 200C is “Ethernet”, no parameter is specified for the “CAN ID” field. In a case where a message including a port number of “50202” is being transmitted in the in-vehicle network, the relay 140B is turned off, due to the fifth power supply control trigger for the facial recognition camera 200C.

Referring back to FIG. 3, the identification unit 161 monitors, for example, messages being transmitted in the in-vehicle network. The identification unit 161 identifies port numbers included in the monitored messages. In a specific example, when the switch circuit 120 has received a message to be relayed (message whose destination is not the management ECU 100), the switch circuit 120 outputs the received message to the control circuit 110. The identification unit 161 analyzes the message outputted from the switch circuit 120, and identifies a port number included in the message.

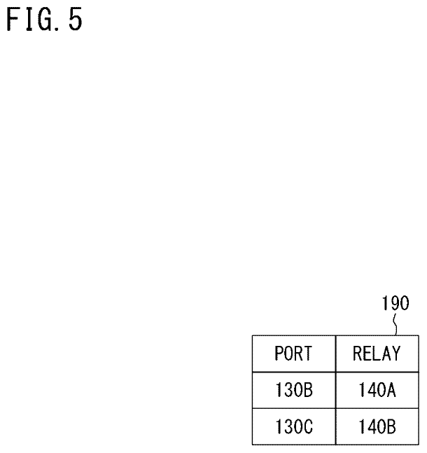

The port table 190 defines the correspondence relationship between the ports 130A, 130B, 130C, 130D which are connected to devices, and the relays 140A, 140B, 140C. That is, in the port table 190, a port and a relay connected to the same device are associated with each other. FIG. 5 shows a first example of the port table. In an example in FIG. 5, the port 130B to which the facial recognition ECU 200B is connected and the relay 140A to which the facial recognition ECU 200B is connected, are associated with each other. Further, the port 130C to which the facial recognition camera 200C is connected and the relay 140B to which the facial recognition camera 200C is connected, are associated with each other.

Referring back to FIG. 3, the control unit 163 identifies a relay corresponding to a port connected to the device, from the port table 190. The control unit 163 controls the identified relay according to the power supply control tables 170A, 170B.

For example, the control unit 163 identifies a port connected to the device, based on a device ID. That is, the control unit 163 judges whether or not the conditions for a power supply control trigger are satisfied, for each of the power supply control triggers defined in the power supply control tables 170A, 170B. If a power supply control trigger whose conditions are satisfied is present in any of the power supply control tables 170A, 170B, the control unit 163 determines a device ID specified in each power supply control table that defines such a power supply control trigger, as a device ID of a power supply control target. The control unit 163 identifies a port to which the target device is connected, based on the device ID, and identifies a relay corresponding to the identified port from the port table 190. The control unit 163 controls the identified relay according to the power supply control trigger whose conditions are satisfied in each power supply control table.

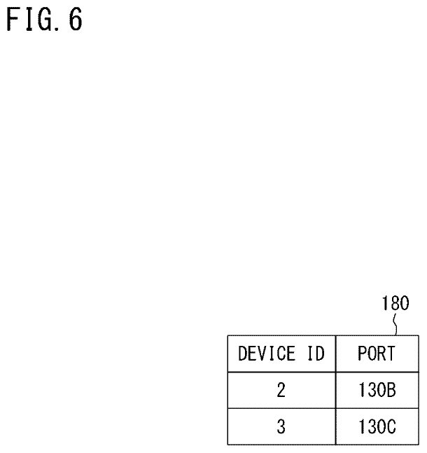

For example, in order to identify a port corresponding to a device ID, the connection table 180 is used. FIG. 6 shows a first example of the connection table. The connection table 180 defines the correspondence relationship between device IDs and the ports 130A, 130B, 130C, 130D that are connected to the corresponding devices. That is, in the connection table 180, each device ID and the port to which the device identified by the device ID is connected, are associated with each other. In an example in FIG. 6, “2” as the device ID of the facial recognition ECU 200B and the port 130B to which the facial recognition ECU 200B is connected, are associated with each other. Further, “3” as the device ID of the facial recognition camera 200C and the port 130C to which the facial recognition camera 200C is connected, are associated with each other.

For example, a case where a message including a port number of “50200” is broadcasted from the door control ECU 200A is considered. In this case, the management ECU 100 receives the message including the port number of “50200”. The identification unit 161 analyzes the message and identifies the port number of “50200” included in the message. The port number of “50200” is specified in the third power supply control trigger in the power supply control table 170A and the third power supply control trigger in the power supply control table 170B. The control unit 163 refers to the power supply control tables 170A, 170B, and identifies a device ID of “2” specified in the power supply control table 170A and a device ID of “3” specified in the power supply control table 170B.

The control unit 163 refers to the connection table 180, and identifies a port of “130B” corresponding to the identified device ID of “2” and a port of “130C” corresponding to the identified device ID of “3”.

The control unit 163 refers to the port table 190, and identifies a relay of “140A” corresponding to the identified port of “130B” and a relay of “140B” corresponding to the identified port of “130C”. The control unit 163 controls the identified relay 140A and the identified relay 140B. Accordingly, the relay 140A is switched from the OFF state to the ON state, and the facial recognition ECU 200B starts up. The relay 140B is switched from the OFF state to the ON state, and the facial recognition camera 200C starts up.

In order to identify a relay corresponding to a port, the port table 190 may not necessarily be used. For example, the correspondence relationship between ports and relays may be included in the code of the management program 160.

The detection unit 162 detects the power source state of the vehicle. In a specific example, the detection unit 162 detects whether the current state of the power source 400 is IG ON, IG OFF, ACC ON, ACC OFF, or +B.

For example, a power supply management ECU (not shown) which manages the power source 400 is connected to the in-vehicle network. The power supply management ECU periodically or non-periodically broadcasts a message indicating the current state of the power source 400, or unicasts such a message to a specific destination. The detection unit 162 detects the current power source state by receiving the message transmitted from the power management ECU. In another example, the management ECU 100 may manage the state of the power source 400. In this case, the detection unit 162 can directly detect the power source state by monitoring the state of the power source 400

In a case where a power source state (second power source state) detected by the detection unit 162 matches a power source state (first power source state) included in any of the power supply control tables 170A, 170B, the control unit 163 controls the relays 140A, 140B according to the power supply control tables 170A, 170B.

For example, a case where the state of the power source 400 has transitioned from IG OFF to IG ON is considered. In this case, the detection unit 162 detects a power source state of “IG ON”. In the first power supply control trigger in the power supply control table 170A and the first power supply control trigger in the power supply control table 170B, “IG” and “ON” are specified as the power source state. The control unit 163 refers to the power supply control tables 170A, 170B, and identifies a device ID of “2” specified in the power supply control table 170A and a device ID of “3” specified in the power supply control table 170B. The control unit 163 refers to the connection table 180, and identifies a port of “130B” corresponding to the identified device ID of “2” and a port of “130C” corresponding to the identified device ID of “3”.

The control unit 163 refers to the port table 190, and identifies a relay of “140A” corresponding to the identified port of “130B” and a relay of “140B” corresponding to the identified port of “130C”. The control unit 163 controls the identified relay 140A and the identified relay 140B. Accordingly, the relay 140A is switched from the OFF state to the ON state, and the facial recognition ECU 200B starts up. The relay 140B is switched from the OFF state to the ON state, and the facial recognition camera 200C starts up.

As described above, a new device may be connected to the management ECU 100. The management ECU 100 can perform power supply control on the connected new device.

In a case where a new device is added to the in-vehicle network, the addition unit 165 adds a power supply control table corresponding to the new device.

For example, the reception unit 164 receives, from a new device added to the in-vehicle network, a device ID for identifying the new device. The addition unit 165 adds a power supply control table associated with the device ID received by the reception unit 164.

In a more specific example, the external storage unit 150 stores therein a plurality of candidate tables which are candidates for device control tables. For example, power supply control tables for a plurality of devices that may be connected as extension devices are stored in the external storage unit 150 as candidate tables. That is, the plurality of candidate tables stored in the external storage unit 150 also include a candidate table for a device that is not mounted in the vehicle (i.e., a device that is not connected to the management ECU 100).

The addition unit 165 selects a candidate table associated with the device ID received by the reception unit 164, from the plurality of candidate tables stored in the external storage unit 150. The addition unit 165 adds the selected candidate table as a device control table. That is, the addition unit 165 adds a copy of the candidate table selected from the external storage unit 150, as the device control table, to the nonvolatile memory 112.

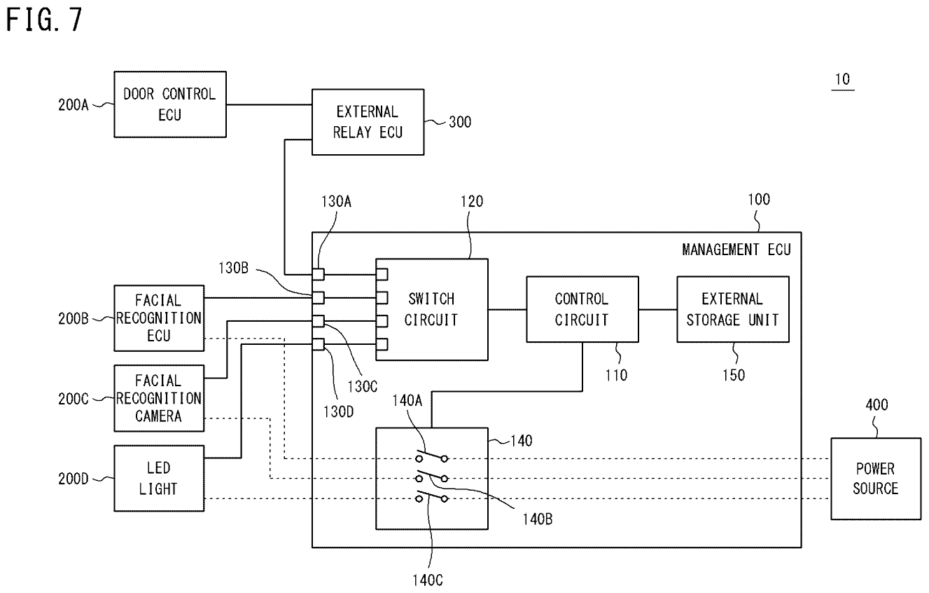

FIG. 7 illustrates an example in which a new device is added in the in-vehicle system according to the embodiment. In an example in FIG. 7, an LED light 200D is added to the in-vehicle system 10. That is, the LED light 200D is a new device. The LED light 200D is an LED light for facial recognition. That is, the LED light 200D is disposed in the vicinity of the facial recognition camera 200C, and turns on, when the facial recognition camera 200C captures an image.

The LED light 200D can perform communication through Ethernet. The LED light 200D is connected to the port 130D of the management ECU 100 via an Ethernet cable.

The LED light 200D is connected to the relay 140C via a power line. When the relay 140C is in the OFF state, no power is supplied to the LED light 200D. When the relay 140C is in the ON state, power is supplied to the LED light 200D, and the LED light 200D starts up.

When the LED light 200D is connected to the management ECU 100, the LED light 200D performs, for example, communication complying with LLDP (Link Layer Discovery Protocol). That is, the LED light 200D and the management ECU 100 transmit and receive LLDP frames. Specifically, the management ECU 100 notifies the LED light 200D of the port 130D to which the LED light 200D is connected, using LLDP. The LED light 200D transmits port information (information on the port 130D to which the LED light 200D is connected) acquired using LLDP, together with the device ID of the LED light 200D, to the management ECU 100. Here, a device ID of the LED light 200D is “4”.

The reception unit 164 receives the device ID and the port information transmitted from the LED light 200D. The addition unit 165 adds a power supply control table associated with the device ID received by the reception unit 164.

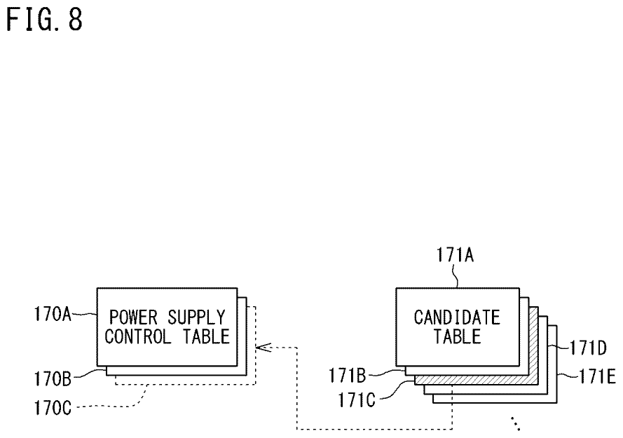

FIG. 8 illustrates an example in which a power supply control table is added. The external storage unit 150 stores therein a plurality of candidate tables 171A, 171B, 171C, 171D, 171E, . . . . The candidate table 171C corresponds to the LED light 200D. That is, the candidate table 171C includes “4” as a device ID of the LED light 200D. The addition unit 165 selects the candidate table 171C including a device ID of “4”, among the plurality of candidate tables 171A, 171B, 171C, 171D, 171E, . . . stored in the external storage unit 150. The addition unit 165 adds a copy of the selected candidate table 171C, as the power supply control table 170C, to the nonvolatile memory 112.

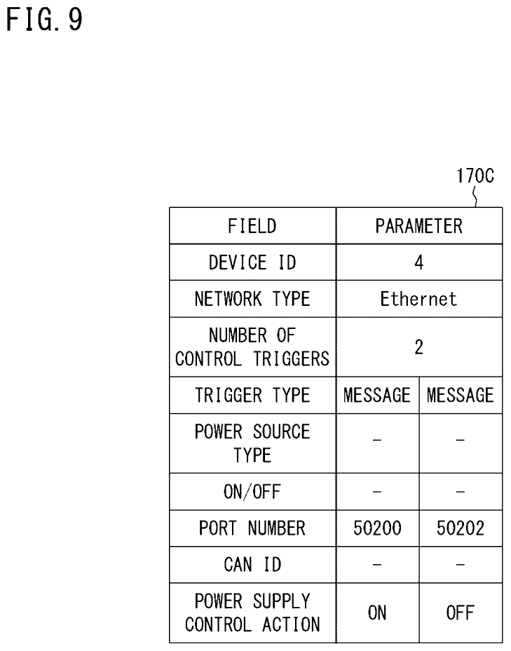

FIG. 9 shows a third example of the power supply control table. In FIG. 9, the power supply control table 170C for the LED light 200D is shown.

In the power supply control table 170C, “4” as the device ID of the LED light 200D is specified.

The network type supported by the LED light 200D is “Ethernet”.

The number of control triggers defined in the power supply control table 170C is the number of power supply control triggers for controlling the relay 140C connected to the LED light 200D. In an example in FIG. 9, a parameter for the “number of control triggers” field is “2”.

In a first power supply control trigger for the LED light 200D, a parameter “message” for the “trigger type” field, a parameter “50200” for the “port number” field, and a parameter “ON” for the “power supply control action” field are specified. Since the first power supply control trigger for the LED light 200D is a power supply control trigger to be caused by a message, no parameter is specified for the “power source type” field or the “ON/OFF” field. Since the network type supported by the LED light 200D is “Ethernet”, no parameter is specified for the “CAN ID” field. In a case where a message including a port number of “50200” is being transmitted in the in-vehicle network, the relay 140C is turned on, due to the first power supply control trigger for the LED light 200D.

In a second power supply control trigger for the LED light 200D, a parameter “message” for the “trigger type” field, a parameter “50202” for the “port number” field, and a parameter “OFF” for the “power supply control action” field are specified. Since the second power supply control trigger for the LED light 200D is a power supply control trigger to be caused by a message, no parameter is specified for the “power source type” field or the “ON/OFF” field. Since the network type supported by the LED light 200D is “Ethernet”, no parameter is specified for the “CAN ID” field. In a case where a message including a port number of “50202” is being transmitted to the in-vehicle network, the relay 140C is turned off, due to the second power supply control trigger for the LED light 200D.

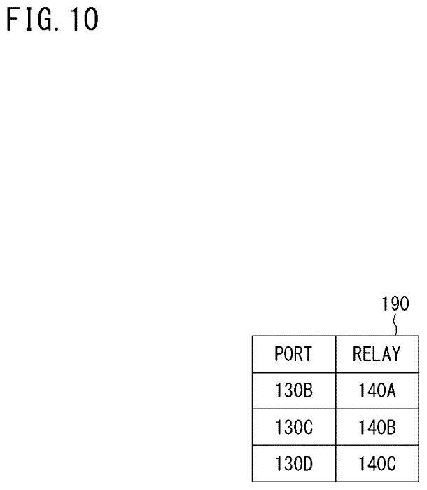

Referring back to FIG. 3, in a case where a new device is added to the in-vehicle network, the registration unit 166 registers the correspondence relationship between a port to which the new device is connected and a relay connected to the new device, in the port table 190. FIG. 10 shows a second example of the port table. For example, in a case where the LED light 200D is added to the in-vehicle system 10, the device ID of the LED light 200D and the port information are notified from the LED light 200D, as described above. The registration unit 166 adds a port of “130D” notified from the LED light 200D and a relay of “140C” to which the LED light 200D is connected, in association with each other to the port table 190.

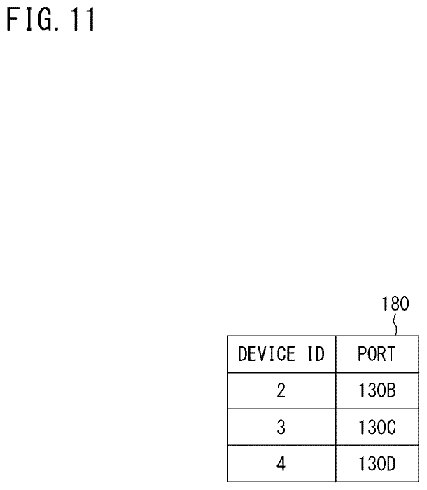

Referring back to FIG. 3, in a case where a new device is added to the in-vehicle network, the registration unit 166 may further register the correspondence relationship between the device ID of the new device and the port to which the new device is connected, in the connection table 180. FIG. 11 shows a second example of the connection table. For example, in a case where the LED light 200D is added to the in-vehicle system 10, the registration unit 166 adds the device ID of “4” notified from the LED light 200D and the port of “130D” notified from the LED light 200D, in association with each other to the connection table 180.

### Operation of In-Vehicle System

Next, the operation of the management ECU 100 according to the embodiment will be described.

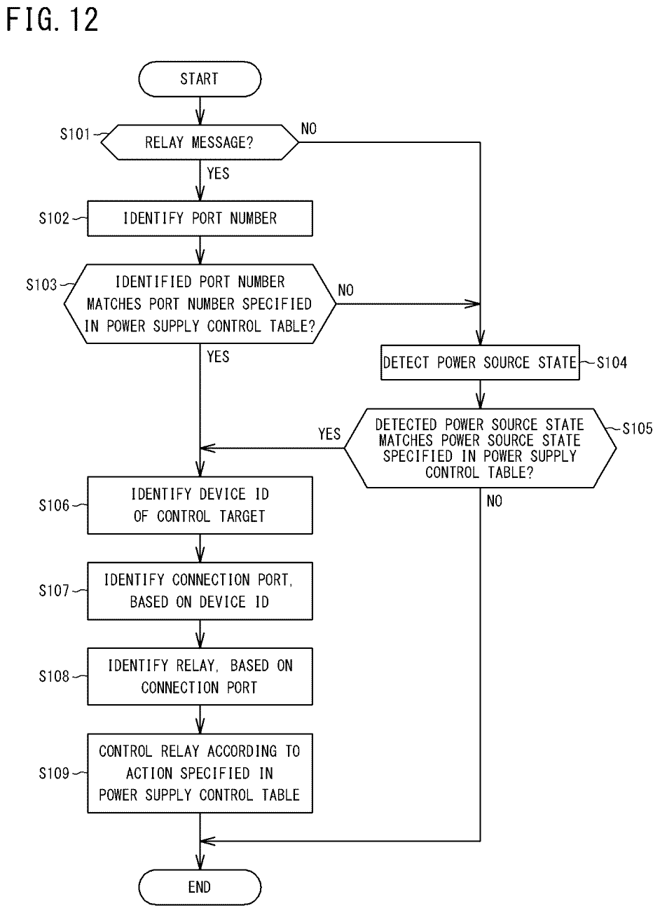

FIG. 12 is a flowchart showing an example of a power supply control process in the management ECU according to the embodiment. The following power supply control process is performed through execution of the management program 160 by the processor 111 of the management ECU 100.

The processor 111 monitors messages being transmitted in the in-vehicle network. The processor 111 judges whether or not a message to be relayed has been received (step S101). If the message to be relayed has been received (YES in step S101), the processor 111 identifies a port number included in the message (step S102).

The processor 111 refers to the power supply control tables 170A, 170B, and judges whether or not the identified port number matches at least one of port numbers specified in the power supply control tables 170A, 170B (step S103).

If the identified port number matches at least one of the port numbers specified in the power supply control tables 170A, 170B (YES in step S103), the processor 111 proceeds to step S106.

If no message to be relayed has been received (NO in step S101), or if the identified port number does not match any of the port numbers specified in all the power supply control tables 170A, 170B (NO in step S103), the processor 111 detects the power source state of the vehicle (step S104).

The processor 111 refers to the power supply control tables 170A, 170B, and judges whether or not the detected power source state matches at least one of power source states specified in the power supply control tables 170A, 170B (step S105).

If the detected power source state matches at least one of the power source states specified in the power supply control tables 170A, 170B (YES in step S105), the processor 111 proceeds to step S106.

If the detected power source state does not match any of the power source states specified in all the power supply control tables 170A, 170B (NO in step S105), the processor 111 ends the power supply control process.

The processor 111 identifies a device ID of a control target (step S106). That is, the processor 111 identifies a device ID specified in the power supply control table including a port number that matches the identified port number or the power supply control table including a power source state that matches the detected power source state.

The processor 111 refers to the connection table 180, and identifies a connection port corresponding to the device ID (port connected to a control target device) (step S107).

The processor 111 refers to the port table 190, and identifies a relay corresponding to the identified connection port (step S108).

The processor 111 controls the identified relay according to a power supply control action specified in a power supply control table including a port number that matches the identified port number or a power supply control table including a power source state that matches the detected power source state (more specifically, the power supply control action specified in a power supply control trigger including a port number that matches the identified port number or a power supply control trigger including a power source state that matches the detected power source state) (step S109). This is the end of the power supply control process.

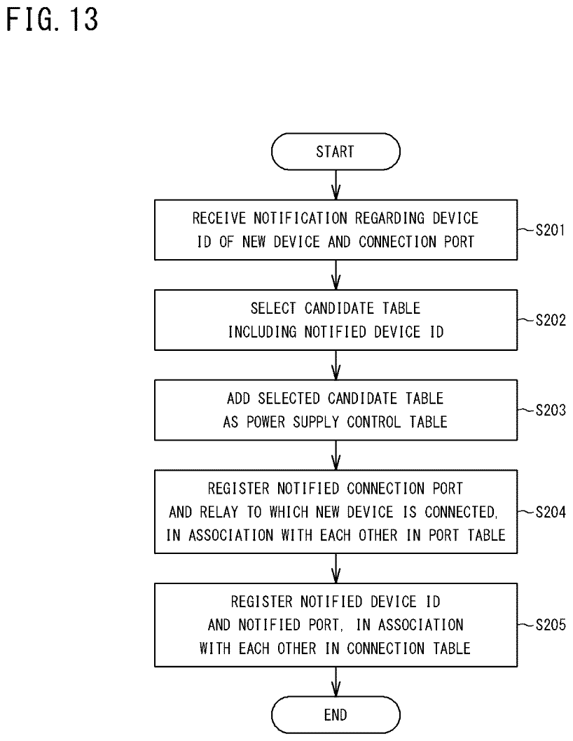

FIG. 13 is a flowchart showing an example of a device addition process in the management ECU according to the embodiment. The following device addition process is performed through execution of the management program 160 by the processor 111 of the management ECU 100.

When a new device is connected to a port of the management ECU 100, the new device acquires port information for identifying the port to which the new device is connected, using LLDP. The new device notifies the management ECU 100 of a device ID of the device and the acquired port information. The processor 111 receives a notification regarding the device ID of the new device and the port information (step S201).

The processor 111 selects a candidate table including the notified device ID, from a plurality of candidate tables stored in the external storage unit 150 (step S202).

The processor 111 adds the selected candidate table (copy thereof), as a power supply control table, to the nonvolatile memory 112 (step S203).

The processor 111 registers the notified connection port and a relay to which the new device is connected, in association with each other in the port table 190 (step S204).

The processor 111 registers the notified device ID and the notified connection port, in association with each other in the connection table 180 (step S205). This is the end of the device addition process.

### Modification

In the above-described embodiment, the in-vehicle system 10 is configured using an Ethernet network. However, the present disclosure is not limited thereto. The in-vehicle system 10 may be configured using a CAN network. The in-vehicle system 10 may include both the CAN network and the Ethernet network. In this case, the management ECU 100 may include a protocol conversion function between CAN and Ethernet. In a case where the in-vehicle system 10 includes the CAN network, a device connected to the management ECU 100 may be capable of communication through CAN protocol.

In the above-described embodiment, the external storage unit 150 mounted in the management ECU 100 stores therein the plurality of candidate tables 171A, 171B, 171C, 171D, 171E, . . . . However, the present disclosure is not limited thereto. For example, the plurality of candidate tables 171A, 171B, 171C, 171D, 171E, . . . may be stored in a server outside the vehicle. In this case, when a new device is added, the management ECU 100 may download a candidate table including the device ID of the new device from the server, and may add the downloaded candidate table as a power supply control table.

### Additional Note

An in-vehicle system including: a management device connected to an in-vehicle network, and one or more devices connected to the in-vehicle network, wherein the management device includes: one or more power supply control tables that are provided respectively for the one or more devices and that each define a relationship between first service identification information for identifying a service and a relay state for a power supply relay configured to switch power supply to the device on and off; an identification unit configured to identify second service identification information included in a message being transmitted in the in-vehicle network; and a control unit configured to control the power supply relay according to the power supply control table, if the second service identification information identified by the identification unit matches the first service identification information included in the power supply control table.

### Supplementary Note

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

What is claimed is:

1. A management device comprising:
one or more power supply control tables that are provided respectively for one or more devices connected to an in-vehicle network and that each define a relationship between first service identification information for identifying a service and a relay state for a power supply relay configured to switch power supply to the device on and off;
an identification unit configured to identify second service identification information included in a message being transmitted in the in-vehicle network; and
a control unit configured to control the power supply relay according to the power supply control table, if the second service identification information identified by the identification unit matches the first service identification information included in the power supply control table.

2. The management device according to claim 1, wherein the power supply control tables each further define a relationship between a first power source state which is a power source state specified and the relay state for the power supply relay,
the management device further comprises a detection unit configured to detect a power source state of a vehicle, and
if a second power source state which is the power source state detected by the detection unit matches the first power source state included in the power supply control table, the control unit controls the power supply relay according to the power supply control table.

3. The management device according to claim 1, further comprising an addition unit configured to, if a new device is added to the in-vehicle network, add a new power supply control table corresponding to the new device.

4. The management device according to claim 3, wherein the power supply control table is associated with device identification information for identifying a device,
the management device further comprises a reception unit configured to receive new device identification information for identifying the new device from the new device added to the in-vehicle network, and
the addition unit adds the new power supply control table with which the new device identification information received by the reception unit is associated.

5. The management device according to claim 4, further comprising a storage unit configured to store therein a plurality of candidate tables which are candidates for device control tables, wherein
the addition unit selects a candidate table associated with the new device identification information from the plurality of candidate tables stored in the storage unit, and adds the selected candidate table as a new device control table.

6. The management device according to claim 1, wherein the management device is a relay device configured to relay a message between a plurality of devices, and
the identification unit monitors a message being transmitted in the in-vehicle network, and identifies the second service identification information included in the message.

7. The management device according to claim 6, further comprising a port table that defines a correspondence relationship between a port connected to the device, and the power supply relay, wherein
the control unit identifies the power supply relay corresponding to the port connected to the device from the port table, and controls the identified power supply relay according to the power supply control table.

8. The management device according to claim 7, further comprising a registration unit configured to, if a new device is added to the in-vehicle network, register a correspondence relationship between a port to which the new device is connected and a power supply relay connected to the new device, in the port table.

9. A management method, comprising:
a step of identifying service identification information included in a message being transmitted in an in-vehicle network; and
a step of, if first service identification information which is service identification information in one or more power supply control tables that are provided respectively for one or more devices connected to the in-vehicle network and that each define a relationship between service identification information for identifying a service and a relay state for a power supply relay configured to switch power supply to the device on and off matches second service identification information which is identified service identification information, controlling the power supply relay according to the power supply control table.

10. A non-transitory computer-readable storage medium in which a management program is stored, the management program causing a computer to perform:
a step of identifying service identification information included in a message being transmitted in an in-vehicle network; and
a step of, if first service identification information which is service identification information in one or more power supply control tables that are provided respectively for one or more devices connected to the in-vehicle network and that each define a relationship between service identification information for identifying a service and a relay state for a power supply relay configured to switch power supply to the device on and off matches second service identification information which is identified service identification information, controlling the power supply relay according to the power supply control table.
